(19) United States
(12) Patent Application Publication
(10) Pub. No.: US 2024/0250517 A1
(43) Pub. Date: Jul. 25, 2024

(54) METHOD FOR PROVIDING THERMAL PROTECTION TO A PRE-CHARGE UNIT AND ELECTRIC POWER CONVERSION SYSTEM FOR EXECUTING THE METHOD

(71) Applicant: Danfoss Power Electronics A/S, Gråsten (DK)

(72) Inventors: Zhi Gao, Chapel Hill, NC (US); Stefan Schroeder, Munich (DE); Markus Sjoblom, Holly Springs, NC (US); Kenneth Dean, Ooltewah, TN (US)

(21) Appl. No.: 18/416,451

(22) Filed: Jan. 18, 2024

(30) Foreign Application Priority Data
Jan. 25, 2023 (DE) 102023101791.8

(51) Int. Cl. H02H 5/04; H02M 7/00; H02M 7/537

(52) U.S. Cl. CPC H02H 5/047; H02M 7/537; H02M 7/003

(57) ABSTRACT

A method for providing thermal protection to a pre-charge unit (PRC) of an electric power conversion system, such as a medium-voltage adjustable-speed drive, with a step-up transformer and a DC link includes the steps of executing a parameter identification block identifying the electrical and thermal parameters of the PRC; of an electric power conversion system executing a current estimation block estimating the current flowing though the PRC's step-up transformer based on a voltage input; executing a thermal level estimation block estimating a thermal level at the PRC's step-up transformer based on the estimated current flowing though the PRC's step-up transformer; executing a protection logic block comparing the estimated thermal level to a pre-determined trip threshold to determine whether a thermal overload has occurred; and outputting a trip signal if the trip threshold has been exceeded. The disclosure further discloses an electric power conversion system, such as a medium-voltage adjustable-speed drive, with a step-up transformer and a DC link for executing a corresponding method.

### CROSS-REFERENCE TO RELATED APPLICATION

This application claims foreign priority benefits under 35 U.S.C. § 119 from European Patent Application No. 102023101791.8, filed Jan. 25, 2023, the content of which is hereby incorporated by reference in its entirety.

### TECHNICAL FIELD

The present invention pertains to a method for providing thermal protection to a pre-charge unit (PRC) comprising a step-up transformer of an electric power conversion system, such as a medium-voltage adjustable-speed drive having e.g. 3300V or 4160V output voltage and typical power ratings between 1 and 10 MW, with a DC link. The method comprises the steps of
executing a parameter identification block, identifying the electrical and thermal parameters of the PRC; of an electric power conversion system executing a current estimation block estimating the current flowing though the PRC's step-up transformer based on a voltage input;
executing a thermal level estimation block, estimating a thermal level at the PRC's step-up transformer based on the estimated current flowing though the PRC's step-up transformer;
executing a protection logic block, comparing the estimated thermal level to a pre-determined trip threshold to determine whether a thermal overload has occurred; and
outputting a trip signal if the trip threshold has been exceeded.

The invention is also directed at an electric power conversion system, such as a medium-voltage adjustable-speed drive, with a pre-charge unit (PRC) including a step-up transformer and a DC link for executing a corresponding method.

### BACKGROUND

Methods for providing thermal protection for pre-charge units of electric power conversion systems are known from the art. Prior art solutions typically require dedicated and often expensive current sensors, as well as associated electronic hardware that is capable of acquiring and sampling current sensor output waveforms at a sampling frequency of at least a few kilohertz. The prior art solutions also require fast digital signal processing hardware, capable of processing sampled currents at least every few hundred microseconds. A problem of the hardware of known prior art solutions is therefore that it comprises costly components, which results in overall expensive power conversion systems.

### SUMMARY

The aim of the present invention is to provide an improved method for providing thermal protection to a pre-charge unit of an electric power conversion system and an improved electric power conversion system, which overcome this problem.

This aim is reached by a method according to claim 1 and a device according to claim 11. Preferable embodiments are subject to the dependent claims.

According to claim 1, a method for providing thermal protection to a pre-charge unit (PRC) comprising a step-up transformer of an electric power conversion system is provided. The electric power conversion system may be a medium-voltage adjustable-speed drive, with a DC link. The method comprises the steps of executing a parameter identification block, identifying the electrical and thermal parameters of the PRC;
executing a current estimation block, estimating the current flowing though the PRC's step-up transformer based on a voltage input;
executing a thermal level estimation block, estimating a thermal level at the PRC's step-up transformer based on the estimated current flowing though the PRC's step-up transformer;
executing a protection logic block, comparing the estimated thermal level to a pre-determined trip threshold to determine whether a thermal overload has occurred; and
outputting a trip signal if the trip threshold has been exceeded.

The invention makes a novel and cost-effective use of existing voltage sensors to estimate currents flowing through a PRC. The estimated current is used for providing thermal overload protection against overheating. Compared to conventional thermal overload protection, which relies on dedicated current sensing and fast digital signal processing, this invention eliminates the need for potentially expensive current sensors and fast digital signal processors. The invention reduces the digital signal processing bandwidth requirement by a few orders of magnitude.

In a preferred embodiment of the invention, the parameter identification block takes a voltage selection board rating V_{SB}, a low-voltage AC power supply's nominal voltage V₁ in root-mean-square Volts and/or a low-voltage AC power supply's nominal frequency fₑ in Hz as its input. The method offers different ways for providing thermal protection, as it may be carried out using different voltage inputs.

In another preferred embodiment of the invention, the parameter identification block produces the step-up transformer's ratio N₂/N₁, the step-up transformer's low-voltage winding resistance R₁ in Ω, the step-up transformer's medium-voltage winding resistance R₂ in Ω, the step-up transformer's heat-up thermal time constant τ_{th,H} in seconds and/or the step-up transformer's cool-down thermal time constant τ_{th,C} in seconds as its output.

In another preferred embodiment of the invention, the parameter identification block is executed once and/or the current estimation block and/or the thermal level estimation block and/or the protection logic block are executed at fixed time intervals, at different time intervals and/or at varying time intervals.

In another preferred embodiment of the invention, the current estimation block and/or the thermal level estimation block and/or the protection logic block are executed at time intervals that are longer than the time period of the supply frequency, preferably at time intervals of 25 ms, 50 ms, 100 ms, 200 ms or 500 ms. The time intervals are not limited to the examples but may also be other intervals. This time interval may be an already existing update rate of a control unit of the power conversion system.

In another preferred embodiment of the invention, the current estimation block estimates the current flowing though the PRC's step-up transformer based on V_{DC} voltage measurements at the DC link.

In another preferred embodiment of the invention, the current estimation block calculates an amplitude modulation ratio mₐ from measured V_{DC} and the highest peak voltage V_{P}.

In another preferred embodiment of the invention, the current estimation block calculates an RMS current from equation (14)

$${I}_{1} = {k}_{th} \cdot {I}_{MQ , RMS} \cdot \frac{{N}_{2}}{{N}_{1}} ,$$

wherein I_{MQ,RMS} is the RMS current flowing through diodes D₅ and D₆ of the PRC diode rectifier assembly derived from equation (13)

$${I}_{MQ , RMS} = \frac{{V}_{MQ , RMS}}{{R}_{1}^{′} + {R}_{2}} ,$$

wherein V_{MQ,RMS} is the RMS voltage across diodes D₅ and D₆ of the PRC diode rectifier assembly derived from equation (12)

$$η = \frac{{V}_{MQ , RMS}^{2}}{{V}_{P}^{2}} = \frac{1}{π} \cdot [ ( π - 2 α ) ( 1 - \frac{cos ( 2 α )}{2} ) - \frac{3}{2} sin ( 2 α ) ] ,$$

and wherein the diode's turn-on angle α and the conversion ratio n are derived from a look-up table relating α and η to the amplitude modulation ratio mₐ.

In another preferred embodiment of the invention, the only sensor used for executing the method is a voltage sensor. The only sensor may be understood to refer to one or more voltage sensors. The voltage sensor may be an electronic circuitry to read a precise voltage level.

In another preferred embodiment of the invention, the trip threshold is pre-determined prior to the execution of the method and/or the parameter identification block is executed once at the beginning of the method.

The invention is also directed at an electric power conversion system, such as a medium-voltage adjustable-speed drive, with a pre-charge unit (PRC) including a step-up transformer and a DC link for executing the presently described method.

### BRIEF DESCRIPTION OF THE DRAWINGS

Further details and advantages of the invention are described with reference to the figures. The figures show:

FIG. 1: components of a pre-charge unit;

FIG. 2: pre-charge unit's circuit diagram;

FIG. 3: overall architecture of the pre-charge unit's thermal protection algorithm;

FIG. 4a: step-up transformer's standard equivalent circuit;

FIG. 4b: step-up transformer's simplified equivalent circuit;

FIG. 5: first-order thermal model; and

FIG. 6: rectified voltage and differential voltage waveforms in pre-charge unit's circuit diagram.

### DETAILED DESCRIPTION

The present invention relates to the thermal protection of pre-charge units (PRCs) without using current or temperature sensors. More specifically, the present invention relates to the continuous estimation of the thermal level or thermal load, wherein only voltage measurements are considered. The PRCs may be protected particularly when operating at either heat-up or cool-down conditions.

Medium-voltage adjustable-speed drives and other power conversion systems are typically used with PRCs. The PRCs take an auxiliary low-voltage AC power supply input, such as 240 V, 440 V or 480 V, and produces a DC output. For medium-voltage adjustable-speed drives, the DC output is a medium-voltage DC output. The DC output energizes a DC link to a pre-determined voltage threshold prior to its connection to a main medium-voltage power supply. This helps reduce the inrush current from the main power supply at the time of connection.

The present invention provides a comprehensive thermal overload protection function for pre-charging units, in particular for medium-voltage drives without increasing the drive's manufacturing cost. Compared to conventional thermal overload protection, which relies on dedicated current sensing, the present invention eliminates the need for such current sensors. Instead, it relies on measurements from an existing medium-voltage DC link voltage sensor. The invention further reduces the digital signal processing bandwidth requirement. Instead of computing a root mean square (RMS) current value every few hundred microseconds, this invention reduces the digital signal processing's bandwidth requirement by computing RMS current say every 100 milliseconds for thermal overload protection purpose. Computing the RMS current is not limited to be made every 100 milliseconds but may also be other intervals.

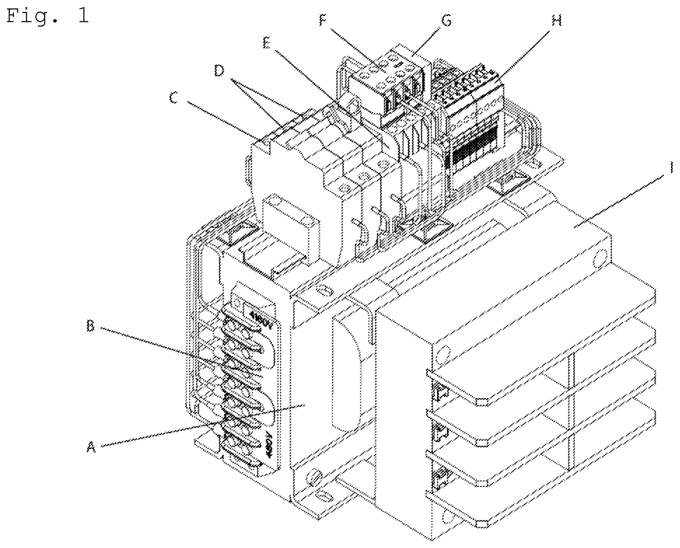

FIG. 1 shows a PRC with its components for a medium-voltage adjustable-speed drive. Major components in the PRC are the step-up transformer A, the voltage selection board B, the shunt trip breaker C, the LV breaker D, the contactor for 24 V DC control E, the auxiliary block for contactors F, the snubber block for contactors G, the contactor assembly for control wiring H and the diode rectifier assembly I. When the PRC operates to energize the medium-voltage DC link, a significant amount of current flows through the step-up transformer A within a short duration. The current consequently produces a large amount of heat in the step-up transformer's A windings.

For the PRC's components shown in FIG. 1, the step-up transformer's A windings have a temperature limit determined by the windings' thermal class. The step-up transformer's A windings are the most vulnerable components to overheating. The thermal protection is focused on providing protection for the step-up transformer's A windings against overheating above the temperature limit determined by the thermal class. For example, a step-up transformer class 105 insulation class A may have a maximum winding temperature of 105° C.

Conventional microprocessor-based thermal protection requires often dedicated current sensors installed on the transformer's primary side. In addition, for low-voltage AC power supply input at 50 or 60 Hz, the thermal protection requires non-trivial electronic circuitry that samples current sensors' outputs at a few thousand samples per second. The microprocessor then performs calculations every few hundred microseconds based on the sampled current I and the sampling time interval t. This I²t value is subsequently compared to a pre-defined trip curve and drive thermal protection logic.

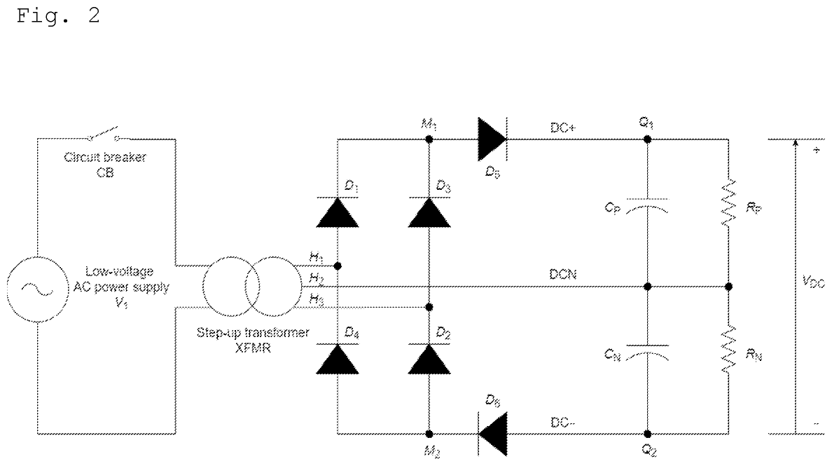

FIG. 2 shows the circuit diagram of a medium-voltage drive's pre-charge unit and its connected components. The low-voltage AC power supply V₁ supplies AC power through a circuit breaker CB to the pre-charge unit's step-up transformer XFMR. The step-up transformer then produces a medium-voltage AC voltage at its output terminals H₁, H₂ and H₃. A diode rectifier assembly, which consists of six diodes D₁ through D₆, subsequently converts the medium-voltage AC voltage to medium-voltage DC voltage. The DC link capacitor C_{P} is connected between the DC link's positive bus DC+ and the DC link's neutral bus DCN. The other DC link capacitor C_{N} is connected between the DC link's neutral bus DCN and the DC link's negative bus DC−. The resistors R_{P} and R_{N} help balance voltages during the medium-voltage drive's normal operation. They also help discharge capacitors C_{P}, C_{N} once the medium-voltage drive is powered off.

The nominal ratings of DC link capacitors C_{P} and C_{N} are usually designed to be identical. The nominal ratings of DC link resistors R_{P} and R_{N} are designed to be identical as well. All diodes D₁ through D₆ have the same nominal ratings. The resistance and inductance values between H₁ and H₂ differ from those between H₂ and H₃ by a few percentage points. Consequently, there is no significant amount of current flowing through the DC link's neutral bus DCN at the time of pre-charging, assuming the leakage current of C_{P} and C_{N} is equal or insignificant.

In accordance with a preferred embodiment of the invention, a method and apparatus to provide continuous and reliable thermal protection to PRCs against overheating are provided. The protection is based on voltage measurements readily available at the DC link in adjustable-speed drives or other power conversion systems. Continuous protection is provided for PRCs during heat-up and/or cool-down conditions. No additional current or temperature sensors are needed. Furthermore, the invention does not require a microprocessor to perform calculations every few hundred microseconds. According to the present invention, the microprocessor performs calculations at a much slower pace of e.g. every few hundred milliseconds. The microprocessor may also be a microcontroller or FPGA device, which may execute codes or functions.

The presently described method can be divided into 4 major steps.

In a first step, a parameter identification block may be executed once. The parameter identification block identifies the PRC's electrical and thermal parameters.

In a second step, a current estimation block may be executed at a fixed time interval. The current estimation block estimates the current flowing through the PRC's step-up transformer.

In a third step, a thermal level estimation block takes the estimated current as its input. The thermal level estimation block then produces an estimated thermal level, preferably at the same fixed time interval as its output.

In a fourth step, a protection logic block compares the estimated thermal level to a pre-determined trip threshold to determine whether a thermal overload has occurred. The protection logic block then generates a trip signal accordingly.

The disclosed method and apparatus may be used for PRCs with transformers in medium-voltage adjustable-speed drives or other power conversion systems.

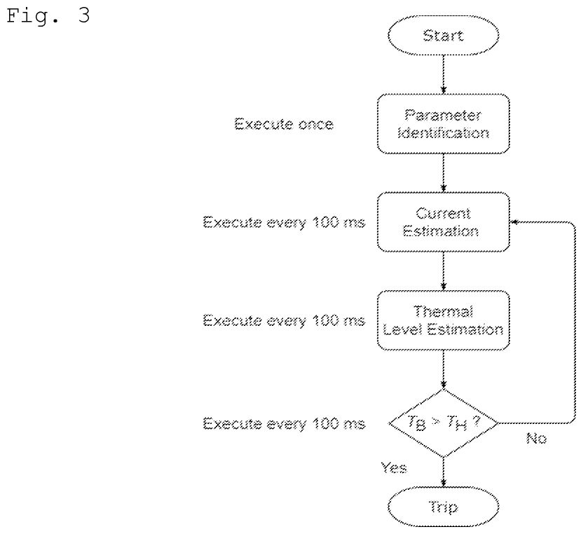

FIG. 3 shows an overall architecture of the PRC's thermal protection algorithm. The protection is based on voltage measurements readily available at the DC link in adjustable-speed drives or other power conversion systems.

The parameter identification block may be executed once. It identifies the PRC's electrical and thermal parameters. The current estimation block may be executed every e.g. 100 ms during the PRC's operation. It estimates the current flowing through the step-up transformer. The estimated current feeds into the thermal level estimation block. This block may be executed every e.g. 100 ms during the PRC's operation. It produces an estimated thermal level T_{B} at its output. The estimated thermal level T_{B} is subsequently compared to a preset thermal threshold T_{H} to determine whether a thermal overload has occurred, and a trip signal is generated accordingly.

Compared to conventional microprocessor-based thermal protection, continuous thermal protection is provided using already existing DC link voltage measurement without involving additional current or temperature sensors. Furthermore, the invention does not require the microprocessor to perform calculations every few hundred microseconds. Instead, the microprocessor performs calculations at a much slower pace of every few hundred milliseconds. In the presently described invention, the calculation may further be simplified through a pre-computed look-up table.

The parameter identification block may be executed once. The input to this identification block may come from a selected database entry or may be manually entered or modified by the user. It may take the following input
voltage selection board rating V_{SB} (240 V, or 440 V or 480 V)
low-voltage AC power supply's nominal voltage V₁ in root-mean-square (RMS) Volts
low-voltage AC power supply's nominal frequency fₑ in Hz and may produce the following electrical parameters at its output
step-up transformer's ratio N₂/N₁
step-up transformer's low-voltage winding resistance R₁ in Ω
step-up transformer's medium-voltage winding resistance R₂ in Ω

The parameter identification block may also produce the following thermal parameters at its output
step-up transformer's heat-up thermal time constant τ_{th,H} in seconds
step-up transformer's cool-down thermal time constant τ_{th,C} in seconds

The output parameters may be calculated using the input parameter or taken from a look-up table.

In addition, the parameter identification block may use the following intermediate quantities internally for its calculation
step-up transformer's VA rating S in V·A

For the low-voltage AC power supply's nominal voltage V₁, equation (1) describes its relationship to the voltage selection board rating V_{SB}. In the absence of any user input, V₁ is usually the same as V_{SB}. However, it is also possible that an end user specifies a value for V₁ that is less than V_{SB}.

$${V}_{1} = \{ \begin{matrix}{V}_{SB} & Normal case \\ User input & Special case\end{matrix} \qquad ( 1 )$$

For example, a customer may specify V_{SB}=440 V, and due to application limitation may use a 230 V power supply to charge the medium-voltage DC link. In this case, V₁=230 V.

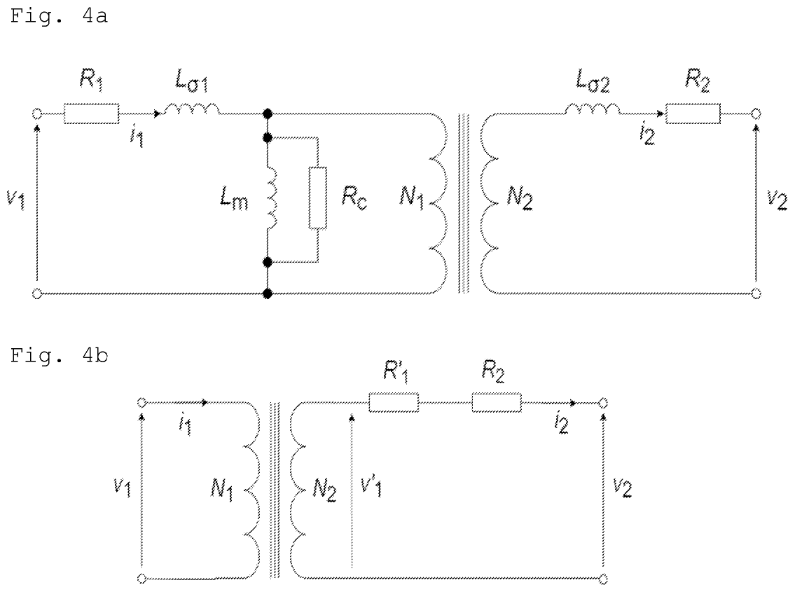

FIG. 4a shows a standard equivalent circuit of the step-up transformer. In FIG. 4a, N₁ and N₂ are the number of turns in low- and medium-voltage windings, respectively. R₁ and R₂ are the low- and medium-voltage winding's resistances, respectively. L_{σ1} and L_{σ2} are the low- and medium-voltage winding's leakage inductances, respectively. Lₘ is the step-up transformer's magnetizing inductance, and Rₑ represents the step-up transformer's core losses.

Table 1 summarizes exemplar electrical parameters for a step-up transformer for the standard equivalent circuit shown in FIG. 4a. Those electrical parameters can be obtained through a series of tests.

TABLE 1
Step-up transformer parameters

| V_{SB} (V) | N₂/N₁ | R₁ (Ω) | L_{σ1}(mH) | R₂ (Ω) | L_{σ2} (mH) | R_{c} (Ω) | Lₘ (H) |
|---|---|---|---|---|---|---|---|
| 240 | 26.53 | 1.98 | 0.97 | 2327.1 | 1197.8 | 4377.7 | 26.3 |
| 440 | 14.42 | 6.25 | 3.63 | 2327.1 | 1197.8 | 14364.0 | 71.6 |
| 480 | 13.22 | 7.97 | 3.80 | 2327.1 | 1197.8 | 16376.0 | 84.3 |

It is apparent that the step-up transformer's magnetizing inductance Lₘ is several orders of magnitude larger than the low-voltage winding's leakage inductance L_{σ1}. The step-up transformer's magnetizing inductance Lₘ is also several orders of magnitude larger than the medium-voltage winding's leakage inductance L_{σ2} when it is referred to the step-up transformer's low-voltage side. Therefore, for the thermal protection purpose, the magnetizing inductance Lₘ may be neglected without introducing significant error in calculating the low-voltage current i₁.

Similarly, the step-up transformer's core loss resistor Rₑ is several orders of magnitude larger than the low-voltage winding's resistances R₁. The step-up transformer's core loss resistor R_{c} is also several orders of magnitude larger than the medium-voltage winding's resistance R₂ when it is referred to the step-up transformer's low-voltage side. Therefore, for the thermal protection purpose, the core loss resistor R_{c} may be neglected without introducing significant error in calculating the low-voltage current i₁.

Furthermore, for any voltage selection board V_{SB} at 50 or 60 Hz, the low-voltage winding's resistance R₁ is 3 to 4 times larger than the equivalent reactance of the low-voltage winding's leakage inductance L_{σ1}. The medium-voltage winding's resistance R₂ is also about 4 times larger than the equivalent reactance of the medium-voltage winding's leakage inductance L_{σ2}. Consequently, the overall low-voltage winding impedance is mostly resistive, and the overall medium-voltage winding impedance is mostly resistive as well. Therefore, for the thermal protection purpose, both the low-voltage winding's leakage inductance L_{σ1} and the medium-voltage winding's leakage inductance L_{σ2} may be neglected without introducing significant error in calculating the low-voltage current i₁.

As a result, the step-up transformer's standard equivalent circuit shown in FIG. 4a is reduced to a simplified equivalent circuit shown in FIG. 4b. Note that R′₁(in Ω) is the low-voltage winding's resistance R₁ referred to the medium-voltage side via the following

$${R}_{1}^{′} = {{R}_{1} ( \frac{{N}_{2}}{{N}_{1}} )}^{2} \qquad ( 2 )$$

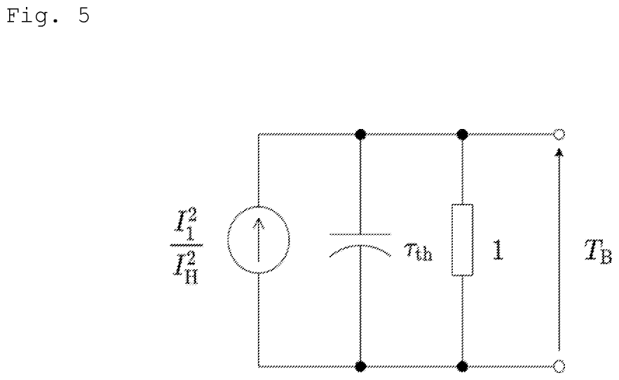

The thermal protection for the step-up transformer is described by a first-order thermal model shown in FIG. 5. In FIG. 5, The I₁ (in Amps) is the RMS current in the step-up transformer's low-voltage winding. The τₜₕ (in seconds) is the step-up transformer's the thermal time constant. The T_{B} is the step-up transformer's thermal level above its ambient. The first-order thermal model in FIG. 5 is characterized by the following equation

$${τ}_{th} \frac{{dT}_{B}}{dt} + {T}_{B} = \frac{{I}_{1}^{2}}{{I}_{H}^{2}} \qquad ( 3 )$$

When implementing the thermal protection digitally in a microprocessor, equation (3) is transformed from continuous- to discrete-time domain

$${τ}_{th} \cdot \frac{{T}_{B} ( n ) - {T}_{B} ( n - 1 )}{Δ t} + {T}_{B} ( n ) = \frac{{I}_{1}^{2}}{{I}_{H}^{2}} \qquad ( 4 )$$

where n is the discrete-time index, and Δt (in seconds) is the time interval between discrete-time indices n and n−1. Rewriting equation (4) yields

$${T}_{B} ( n ) = \frac{{τ}_{th}}{{τ}_{th} + Δ t} \cdot {T}_{B} ( n - 1 ) + \frac{Δ t}{{τ}_{th} + Δ t} \cdot \frac{{I}_{1}^{2}}{{I}_{H}^{2}} \qquad ( 5 )$$

Equation (5) is the foundation of thermal level estimation block shown in FIG. 3.

When the PRC operates to energize the medium-voltage DC link, the current estimation block executes every e.g. 100 ms, and estimates the current flowing through the step-up transformer. It takes the measured medium-voltage DC link's voltage V_{DC} as its input, and outputs an estimate of the RMS current in the step-up transformer's low-voltage winding I₁. To reduce the total number of computations, the current estimation block may also output I²₁ in lieu of I₁.

The current estimation block is formulated in three steps. First, it calculates a rectified voltage from the low-voltage AC power supply, i.e. the absolute value of the voltage at each moment in time. Second, it calculates a differential voltage from the rectified voltage. Last, it computes the RMS current in the step-up transformer's low-voltage winding from the differential voltage.

According to the simplified equivalent circuit in FIG. 4b, the step-up transformer boosts the low-voltage AC voltage vi to a medium-voltage AC voltage v′₁

$${v}_{1}^{′} = {v}_{1} \cdot \frac{{N}_{2}}{{N}_{1}} \qquad ( 6 )$$

Neglecting the forward voltage drop across diodes in FIG. 2, the diodes D₁ through D₄ in the full-bridge diode rectifier assembly convert the medium-voltage AC v′₁ to a rectified voltage v′_{1R} between M₁ and M₂. Denotes the peak amplitude of the rectified voltage v′_{1R} as V_{P}.

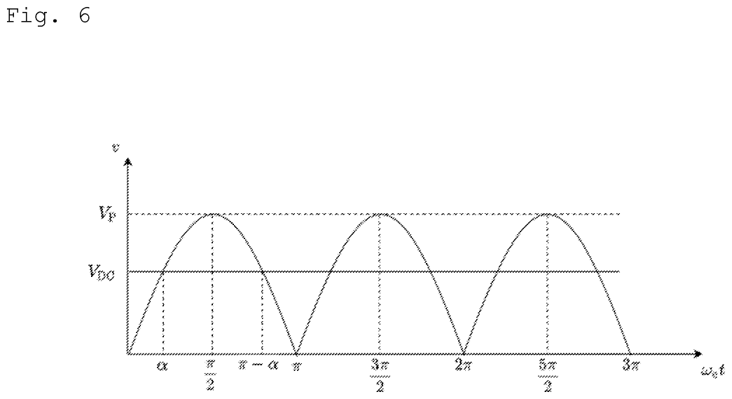

FIG. 6 shows the waveform of the rectified voltage v′IR. Note that de (in radians per second) is the low-voltage AC power supply's nominal angular frequency. It is related to the low-voltage AC power supply's nominal frequency fₑ via ωₑ=2πfₑ.

According to various standards, the low-voltage AC voltage vi is allowed to fluctuate between −10% and +10% around its nominal voltage V₁. Therefore, the highest peak voltage V_{P} is

$${V}_{P} = 110 \% \cdot \sqrt{2} \cdot {V}_{1} \cdot \frac{{N}_{2}}{{N}_{1}} \qquad ( 7 )$$

Consequently, the rectified voltage is

$${v}_{1 R}^{′} = {V}_{P} \vert sin ( {ω}_{e} t ) ‖ \qquad ( 8 )$$

As shown in FIG. 6 and by equation (8), the rectified voltage v′_{1R} repeats every π radians with respect to wet. Therefore, subsequent analysis is focused on ωₑt between 0 and π by taking advantage of this periodicity.

Referring to FIG. 2, the voltage between M₁ and M₂ is the rectified voltage v′_{1R}. The voltage between Q₁ and Q₂ is the medium-voltage DC link's voltage V_{DC}. Therefore, the differential voltage v_{MQ} is defined as the difference between the rectified voltage v′IR and the medium-voltage DC link's voltage V_{DC} when the diodes D₅ and D₆ are conducting, and 0 elsewhere.

FIG. 6 shows the waveform of medium-voltage DC link's voltage V_{DC} superimposed on that of the rectified voltage v′IR. Assuming ideal diodes D₅ and D₆ with no forward voltage drop, and defining mₐ as the amplitude modulation ratio, i.e., mₐ=V_{DC}/V_{P}, the differential voltage V_{MQ} is

$${v}_{M Q} ( t ) = \{ \begin{matrix}0 & 0 \leq {ω}_{e} t < α \\ {V}_{P} [ sin ( {ω}_{e} t ) - {m}_{a} ] & α \leq {ω}_{e} t \leq π - α \\ 0 & π - α < {ω}_{e} t \leq π\end{matrix} \qquad ( 9 )$$

According to FIG. 6, the amplitude modulation ratio mₐ is also related to the diode's turn-on angle α via mₐ=sin(a). It is apparent that 0≤α≤/2, and 0≤mₐ≤1.

It is worth noting that in medium-voltage drive, both V_{P} and V_{DC} are in kV range. They are far greater than the diode's forward voltage drop V_{f}. Therefore, the diode's forward voltage drop V_{f} may be neglected without introducing significant amount of error in subsequent calculations.

The RMS current calculation computes an equivalent RMS current in the step-up transformer's low-voltage winding from the differential voltage. To start with, when the rectifier diode's on resistance is neglected, the instantaneous current that flows through the diodes D₅ and D₆ is

$${i}_{M Q} ( t ) = \frac{{v}_{M Q} ( t )}{{R}_{1}^{′} + {R}_{2}} \qquad ( 10 )$$

The diode's on resistance is neglected because it is small compared to the resistance quantity R′₁+R₂.

The RMS current of i_{MQ}(t) is calculated by first calculating the square of the RMS voltage of v_{MQ}(t) first, and then taking the square root of the result. The square of the RMS voltage of v_{MQ}(t) is calculated via

$${V}_{MQ , RMS}^{2} = \frac{1}{π} \cdot {\int }_{0}^{π} {v}_{M Q}^{2} ( {ω}_{e} t ) d ( {ω}_{e} t ) = \frac{1}{π} \cdot {\int }_{α}^{π - α} {{V}_{p}^{2} [ sin ( {ω}_{e} t ) - {m}_{a} ]}^{2} d ( {ω}_{e} t ) \qquad ( 11 )$$

Simplifying the right side of equation (11), and then re-arranging terms on both the left and right side of equation (11) yields

$$η = \frac{{V}_{MQ , RMS}^{2}}{{V}_{P}^{2}} = \frac{1}{π} \cdot [ ( π - 2 α ) ( 1 - \frac{cos ( 2 α )}{2} ) - \frac{3}{2} sin ( 2 α ) ] \qquad ( 12 )$$

where the conversion ratio η=V²_{MQ,RMS}/V²_{P}. Table 2 provides an exemplary look-up table showing values of ma and their corresponding conversion ratio η. Table 2 may serve as the foundation for the current estimation block shown in FIG. 3.

TABLE 2
Look-up table showing relationship between the
amplitude modulation ratio mₐ, the diode's turn-on
angle α, and the conversion ratio η

| mₐ | α | η |
|---|---|---|
| 0.000 | 0.0 | 0.50 |
| 0.041 | 2.3 | 0.45 |
| 0.084 | 4.8 | 0.40 |
| 0.131 | 7.5 | 0.35 |
| 0.182 | 10.5 | 0.30 |
| 0.239 | 13.8 | 0.25 |
| 0.303 | 17.6 | 0.20 |
| 0.378 | 22.2 | 0.15 |
| 0.470 | 28.1 | 0.10 |
| 0.598 | 36.7 | 0.05 |
| 1.000 | 90.0 | 0.00 |

From equation (10), the RMS current that flows through the diodes D₅ and D₆ is

$${I}_{MQ , RMS} = \frac{{V}_{MQ , RMS}}{{R}_{1}^{′} + {R}_{2}} \qquad ( 13 )$$

Consequently, the step-up transformer's low-voltage winding's RMS current is

$${I}_{1} = {k}_{t h} \cdot {I}_{MQ , RMS} \cdot \frac{{N}_{2}}{{N}_{1}} \qquad ( 14 )$$

where the factor kₜₕ is a coefficient greater than or equal to 1. This factor accounts for additional heating created by harmonics and other distortions in current. In practice, it is useful to start with kₜₕ=1.00 and try different values until one that matches the power quality condition of the low-voltage AC power supply V₁.

Table 2 shows an example of how to calculate RMS current in the step-up transformer's low-voltage winding I₁ from the measured medium-voltage DC link's voltage V_{DC}. In practice, it is useful to have a table with more rows than those in table 2 to help achieve better resolution. For example, the amplitude modulation ratio ma may be divided into 16, 32 or even 64 segments with corresponding conversion ratio η. Similar to those shown in table 2, all conversion ratios are pre-computed and stored in non-volatile memory.

When implementing the look-up table, there are optimized methods to locate a specific entry from the look-up table quickly. For example, a binary search algorithm may be used to reduce the total number of computations to find the location of a specific entry. The mathematical comparison may be replaced by fast and simple bitwise operations, which are directly supported by the microprocessors, to further increase the execution speed.

It is worth noting that in the subsequent thermal level estimation step, the RMS current I₁ is first squared, and then normalized to I2H according to equation (5). It is possible to reduce the total number of computations by combining equations (13) and (14)

$${I}_{1}^{2} = {k}_{t h}^{2} \cdot {I}_{MQ , RMS}^{2} \cdot {( \frac{{N}_{2}}{{N}_{1}} )}^{2} = {k}_{t h}^{2} \cdot \frac{{V}_{MQ , RMS}^{2}}{{( {R}_{1}^{′} + {R}_{2} )}^{2}} \cdot {( \frac{{N}_{2}}{{N}_{1}} )}^{2} = {k}_{t h}^{2} \cdot {( \frac{{N}_{2}}{{N}_{1}} )}^{2} \cdot \frac{{V}_{P}^{2}}{{( {R}_{1}^{′} + {R}_{2} )}^{2}} \cdot η \qquad ( 15 )$$

In equation (15), quantities k²ₜₕ, (N₂/N₁)², V²_{P}, (R′₁+R₂)² may be pre-computed and stored in a microprocessor's non-volatile memory. Once the conversion ratio is obtained from a look-up table similar to table 2 based on measured medium-voltage DC link's voltage V_{DC}, then I²₁ is calculated according to equation (15). This I²₁ may be used directly in the subsequent thermal level estimation block.

In summary, the current estimation block takes the measured medium-voltage DC link's voltage V_{DC} as its input. Then it calculates the amplitude modulation ratio mₐ from this measured V_{DC} and the highest peak voltage Vₚ. Next, the conversion ration is obtained from a pre-computed table that is similar to table 2. Finally, the RMS current in the step-up transformer's low-voltage winding I₁ is calculated from equations (13) and (14). To reduce the total number of computations, the current estimation block may also output I²₁ in lieu of I₁ using equation (15).

For the step-up transformer, because a large amount of inrush current occurs within a short interval, the thermal behaviour of the step-up transformer's hot spot is largely determined by the localized thermal behaviour around the hot spot. In contrast, the step-up transformer's cooling behaviour involves not only the localized thermal behaviour around the hot spot, but also the overall thermal behaviour of the step-up transformer to dissipate the heat to the ambient surrounding.

Consequently, it is useful to use a thermal time constant τ_{th,H} (in seconds) to reflect the step-up transformer's heat-up behaviour, and a separate thermal time constant τ_{th,C} (in seconds) to describe the step-up transformer's cool-down behaviour.

Denoting β=1/I_{H}², then equation (5) may be rewritten as

$${T}_{B} ( n ) = \frac{{τ}_{th , H}}{{τ}_{t h , H} + Δ t} \cdot {T}_{B} ( n - 1 ) + \frac{β \cdot Δ t}{{τ}_{t h , H} + Δ t} \cdot {I}_{1}^{2} \qquad ( 16 )$$

When the time interval between discrete-time indices n and n−1, Δt, is a known quantity, then equation (16) is simplified to

$${T}_{B} ( n ) = a \cdot {T}_{B} ( n - 1 ) + b \cdot {I}_{1}^{2} \qquad ( 17 )$$

$$where a = {τ}_{t h , H} / ( {τ}_{t h , H} + Δ t ) , and b = β \cdot Δ t / ( {τ}_{t h , H} + Δ t ) .$$

When the current estimation block produces a non-zero estimate of I₁², then equation (17) is applied to produce an estimated thermal level T_{B}. When the PRC is disconnected from the low-voltage AC power supply V1, either after the medium-voltage DC link reaches its pre-charge voltage level, or due to a DC pre-charge timeout function, the step-up transformer's cool-down behaviour is described by

$${T}_{B} ( n ) = \frac{{τ}_{th , C}}{{τ}_{th , C} + Δ t} \cdot {T}_{B} ( n - 1 ) \qquad ( 18 )$$

When the time interval between discrete-time indices n and n−1, Δt, is a known quantity, then equation (18) is simplified to

$${T}_{B} ( n ) = c \cdot {T}_{B} ( n - 1 ) \qquad ( 19 )$$

$$where c = {τ}_{t h , C} / ( {τ}_{t h , C} + Δ t ) .$$

When the PRC is disconnected from the low-voltage AC power supply V₁, then equation (19) is applied to produce an estimated thermal level T_{B}. This estimated thermal level T_{B} is useful in determining whether the PRC has enough remaining thermal capacity for another pre-charge operation.

The thermal protection may work in conjunction with a DC pre-charge timeout function to provide comprehensive protection to the step-up transformer. The DC pre-charge timeout function determines the maximum duration to attempt a pre-charge. It disconnects the low-voltage AC power supply V₁ from the PRC after a pre-determined time has elapsed.

When the pre-determined time has not elapsed, the DC pre-charge timeout function does not activate. In this case, if the estimated thermal level TB is less than a pre-determined trip threshold T_{H}, e.g., T_{H}=100%, then no trip signal is generated. Otherwise, a trip signal is generated to disconnect the low-voltage AC power supply V₁ from the PRC.

In addition to the trip signal, an alarm signal may be generated when the thermal level T_{B} is less than or equal to a pre-determined alarm threshold. The alarm threshold is usually set to a value less than the trip threshold T_{H}, e.g., 85%. Once the thermal level T_{B} is equal to or greater than the alarm threshold, the protection logic generates an alarm to warn operators of potential pending thermal overload trip.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A method for providing thermal protection to a pre-charge unit (PRC) comprising a step-up transformer of an electric power conversion system, such as a medium-voltage adjustable-speed drive, with a DC link, comprising the steps of
executing a parameter identification block identifying the electrical and thermal parameters of the PRC;
executing a current estimation block estimating the current flowing though the PRC's step-up transformer based on a voltage input;
executing a thermal level estimation block estimating a thermal level at the PRC's step-up transformer based on the estimated current flowing though the PRC's step-up transformer;
executing a protection logic block comparing the estimated thermal level to a pre-determined trip threshold to determine whether a thermal overload has occurred; and
outputting a trip signal if the trip threshold has been exceeded.

2. The method according to claim 1, wherein the parameter identification block takes a voltage selection board rating V_{SB}, a low-voltage AC power supply's nominal voltage V₁ in root-mean-square Volts and/or a low-voltage AC power supply's nominal frequency fₑ in Hz as its input.

3. The method according to claim 1, wherein the parameter identification block produces the step-up transformer's ratio N₂/N₁, the step-up transformer's low-voltage winding resistance R₁ in Ωj, the step-up transformer's medium-voltage winding resistance R₂ in Ω, the step-up transformer's heat-up thermal time constant τ_{th,H} in seconds and/or the step-up transformer's cool-down thermal time constant τ_{th,C} in seconds as its output.

4. The method according to claim 1, wherein the parameter identification block is executed once and/or that the current estimation block and/or the thermal level estimation block and/or the protection logic block are executed at fixed time intervals, at different time intervals and/or at varying time intervals.

5. The method according to claim 1, wherein the current estimation block and/or the thermal level estimation block and/or the protection logic block are executed at time intervals that are longer than the time period of the supply frequency, preferably at time intervals of 25 ms, 50 ms, 100 ms, 200 ms or 500 ms.

6. The method according to claim 1, wherein the current estimation block estimates the current flowing though the PRC's step-up transformer based on V_{DC} voltage measurements at the DC link.

7. The method according to claim 1, wherein the current estimation block calculates an amplitude modulation ratio mₐ from measured V_{DC} and the highest peak voltage V_{P}.

8. The method according to claim 1, wherein the current estimation block calculates an RMS current from equation (14)
$${I}_{1} = {k}_{th} \cdot {I}_{MQ , RMS} \cdot \frac{{N}_{2}}{{N}_{1}} ,$$
wherein I_{MQ,RMS} is the RMS current flowing through diodes D₅ and D₆ of the PRC diode rectifier assembly derived from equation (13)
$${I}_{MQ , RMS} = \frac{{V}_{MQ , RMS}}{{R}_{1}^{′} + {R}_{2}} ,$$
wherein V_{MQ,RMS} is the RMS voltage across diodes D₅ and D₆ of the PRC diode rectifier assembly derived from equation (12)
$$η = \frac{{V}_{MQ , RMS}^{2}}{{V}_{P}^{2}} = \frac{1}{π} \cdot [ ( π - 2 α ) ( 1 - \frac{cos ( 2 α )}{2} ) - \frac{3}{2} sin ( 2 α ) ] ,$$
and wherein the diode's turn-on angle α and the conversion ratio n are derived from a look-up table relating α and η to the amplitude modulation ratio mₐ.

9. The method according to claim 1, wherein the only sensor used for executing the method is a voltage sensor.

10. The method according to claim 1, wherein the trip threshold is pre-determined prior to the execution of the method and/or that the parameter identification block is executed once at the beginning of the method.

11. An electric power conversion system, such as a medium-voltage adjustable-speed drive, with a pre-charge unit (PRC) including a step-up transformer and a DC link for executing a method according to claim 1.

12. The method according to claim 2, wherein the parameter identification block produces the step-up transformer's ratio N₂/N₁, the step-up transformer's low-voltage winding resistance R₁ in Ωj, the step-up transformer's medium-voltage winding resistance R₂ in Ω, the step-up transformer's heat-up thermal time constant τ_{th,H} in seconds and/or the step-up transformer's cool-down thermal time constant τ_{th,C} in seconds as its output.

13. The method according to claim 2, wherein the parameter identification block is executed once and/or that the current estimation block and/or the thermal level estimation block and/or the protection logic block are executed at fixed time intervals, at different time intervals and/or at varying time intervals.

14. The method according to claim 3, wherein the parameter identification block is executed once and/or that the current estimation block and/or the thermal level estimation block and/or the protection logic block are executed at fixed time intervals, at different time intervals and/or at varying time intervals.

15. The method according to claim 2, wherein the current estimation block and/or the thermal level estimation block and/or the protection logic block are executed at time intervals that are longer than the time period of the supply frequency, preferably at time intervals of 25 ms, 50 ms, 100 ms, 200 ms or 500 ms.

16. The method according to claim 3, wherein the current estimation block and/or the thermal level estimation block and/or the protection logic block are executed at time intervals that are longer than the time period of the supply frequency, preferably at time intervals of 25 ms, 50 ms, 100 ms, 200 ms or 500 ms.

17. The method according to claim 4, wherein the current estimation block and/or the thermal level estimation block and/or the protection logic block are executed at time intervals that are longer than the time period of the supply frequency, preferably at time intervals of 25 ms, 50 ms, 100 ms, 200 ms or 500 ms.
